(19) United States
(12) Patent Application Publication
(10) Pub. No.: US 2006/0169286 A1
(43) Pub. Date: Aug. 3, 2006

(54) Ventilation mask

(76) Inventors: Martin Eifler, Gluckstadt (DE); Gerd Schulz, Schenefeld (DE)

Correspondence Address: FRIEDRICH KUEFFNER, 317 MADISON AVENUE, SUITE 910, NEW YORK, NY, 10017, US

(21) Appl. No.: 11/393,182

(22) Filed: Mar. 29, 2006

Related U.S. Application Data
(63) Continuation-in-part of application No. 10/966,062, filed on Oct. 15, 2004, now abandoned.

(30) Foreign Application Priority Data
Oct. 18, 2003 (DE) 103 48 532.5

(51) Int. Cl. A62B 18/02

(52) U.S. Cl. 128/206.21; 128/206.24; 128/206.26; 128/205.25

(57) ABSTRACT

A ventilation mask used for the ventilation of a patient has a mask base and a contour element that fits on the patient's face. At least one outflow channel for respiratory gas is provided in a transition zone between the base of the mask and the contour element. The outflow channel is bounded at least over portions thereof by a spacing ring arranged between the mask base and the contour element.

### CROSS-REFERENCE TO RELATED APPLICATIONS

This application is a Continuation-in-Part Application of U.S. application Ser. No. 10/966,062.

### BACKGROUND OF THE INVENTION

1. Field of the Invention

The present invention relates to a ventilation mask for the ventilation of a patient, which has a mask base and a contour element that fits on the patient's face.

2. Description of the Related Art

A ventilation mask with a separate expiratory constituent is described, for example in DE-OS 199 03 732. The base of the mask is rigidly connected into a coupling element, which can be coupled with the expiratory constituent. The expiratory constituent can be fitted with a hose adapter, which connects the breathing mask to a ventilation unit via a ventilation hose. A ventilation mask of this type is suitable especially for use in CPAP therapy.

Another ventilation mask is described in DE-OS 101 58 066. A ventilation hose is connected with the ventilation mask by a joint shaped like a spherical segment. An outflow channel for respiratory gas is jointly bounded by an expiratory constituent, on the one hand, and by a coupling element connected with the mask, on the other hand.

It is also known that an expiratory system can be realized in the area of a breathing mask by providing several expiratory openings, which are formed as holes or slots, directly in the base of the mask. However, this produces relatively large expiratory noises directly in the area of the patient's head. This is unacceptable, especially if the mask is to be used during the night.

In general, previously known ventilation masks and expiratory systems are relatively loud, since the expiratory openings have relatively compact geometries and thus do not promote sufficiently diffuse outflow.

### SUMMARY OF THE INVENTION

The object of the present invention is to construct a ventilation mask of the aforementioned type in such a way that sound emission during expiration is low, a small number of parts are used, and a high level of wearing comfort is achieved.

In accordance with the invention, this object is achieved by providing at least one outflow channel for respiratory gas in a transition zone between the base of the mask and the contour element.

Locating the outflow channel in the transition zone between the base of the mask and the contour element helps to provide an outflow channel with a relatively elongated shape, so that low flow velocities of the gas and thus low sound emissions are promoted. Furthermore, this location of the outflow channel makes it possible to dimension the outflow channel relatively narrowly to promote a diffuse outflow of the respiratory gas. Due to the elongated dimensioning of the outflow channel, its narrow dimensioning does not lead to an unfavorable increase in flow resistance, but rather a sufficiently large outflow area is provided.

The arrangement of the outflow channels in the transition zone between the base of the mask and the contour element also supports favorable manufacture of the parts from the standpoint of tool technology. Furthermore, it provides a very high degree of functionality and effective washing out of carbon dioxide, since the outflow channel is positioned relatively close to the patient's nose.

To prevent closure of the outflow channel by deformations of the structural members bordering the outflow channel, it is proposed that the outflow channel be divided by at least one spacing element.

The production of an outflow channel border that can withstand a large load is supported by bounding the outflow channel at least in some areas with a spacing ring arranged between the base of the mask and the contour element.

Simple manufacturing from the standpoint of tool technology is assisted by arranging at least one of the spacing elements in the area of the spacing ring.

Taking typical material properties into consideration, it is found to be advantageous for the spacing element to be arranged in the area of a spacing ring contact surface that faces the base of the mask.

In accordance with another embodiment, at least one of the spacing elements is arranged in the area of the base of the mask.

In another fabrication variant, the spacing element is arranged in the area of a spacing ring contact surface that faces the contour element.

The shape is defined by the fact that the spacing ring bounds an essentially triangular base area with rounded corner regions, which takes typical facial anatomy into consideration.

Favorable flow conveyance is promoted if the outflow channel is bounded in the area of at least one of the triangular legs of the spacing ring.

The production of an outflow channel that is as elongated as possible is assisted by bounding the outflow channel in the area of each triangular leg of the spacing ring.

In a typical selection of materials, the spacing ring is made of a harder material than the contour element.

Simple assembly and handling are assisted by forming the spacing ring and the contour element as a single piece.

Injection of the spacing ring on the contour element is an especially helpful way to contribute to simpler handling.

Another design variant consists in the spacing ring and the contour element being adhesively bonded to each other.

It is also possible for the spacing ring and the contour element to be welded together.

A modular design of the device can be realized by detachably fastening the spacing ring and the base of the mask to each other.

Simple assembly is also assisted by fastening the spacing ring and the base of the mask to each other by a snap connection.

Optimum utilization of this component geometry is achieved by providing this fastening in the transition zones between the triangular legs.

### BRIEF DESCRIPTION OF THE DRAWING

In the drawing:

FIG. 1 is a schematic illustration of a ventilation device with a ventilation mask;

FIG. 2 is a perspective view of a base of the ventilation mask;

FIG. 3 is a perspective view of the base of the mask in accordance with FIG. 2 together with a spacing ring and a contour element;

FIG. 4 shows a top view in viewing direction IV in FIG. 3;

FIG. 5 is a schematic illustration of the spacing ring.

### DESCRIPTION OF THE PREFERRED EMBODIMENTS

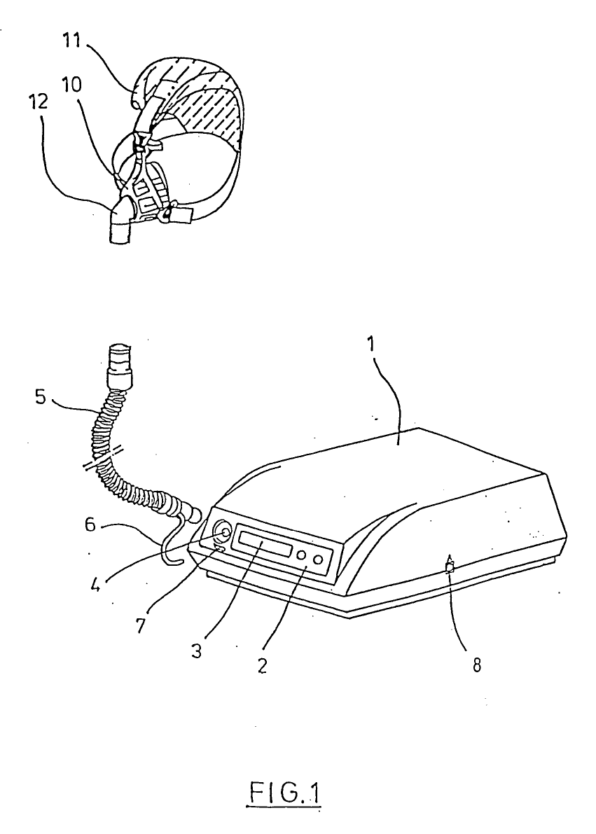

FIG. 1 shows the basic construction of a ventilation device. In the area of the unit housing 1, which has an operating panel 2 and a display 3, a respiratory gas pump is installed in an internal space in the unit. The connecting hose 5 is attached by a coupling 4. An additional pressure-measuring hose 6, which can be connected with the unit housing 1 by a pressure input connection 7, can run along the connecting hose 5. To allow data transmission, the unit housing 1 has an interface 8.

FIG. 1 also shows a ventilation mask 10, which is designed as a nasal mask. The mask can be fastened on the head of a patient by a head fastening device 11. A coupling element 12 is provided in the expanded region of the ventilation mask 10 that faces the connecting hose 5.

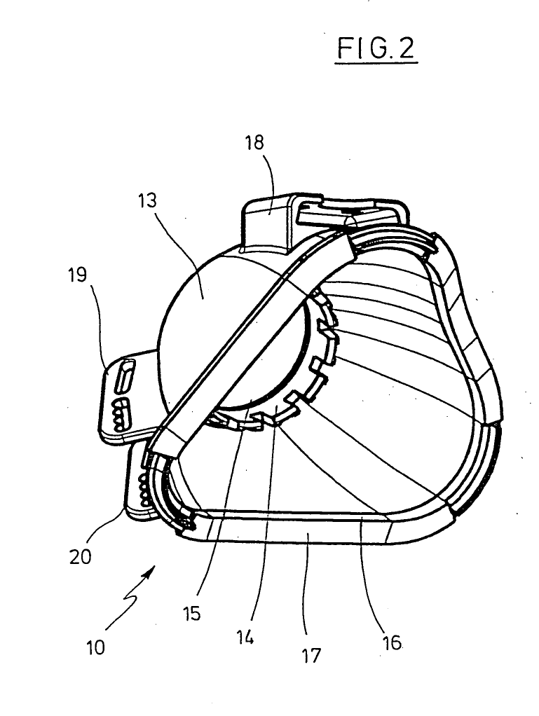

FIG. 2 shows a perspective view of the base 13 of the ventilation mask 10. The base 13 of the mask has a mounting component 14 for the coupling element 12. In the embodiment shown in FIG. 2, the mounting component 14 is designed to receive a part of the coupling element 12 which has the form of a ball joint. The mounting component 14 circumscribes an inlet opening 15 of the base 13 of the mask.

An opening 16 is provided, which faces away from the inlet opening 15 and is bordered by an edge 17. The edge 17 has an essentially triangular contour with three legs that are rounded at their points of transition into each other. FIG. 2 also shows a mounting component 18 for the head fastening device 11 shown in FIG. 1 or for comparable strap-like fastening devices and mounting components 19, 20 for a forehead support, which is not shown in the drawings.

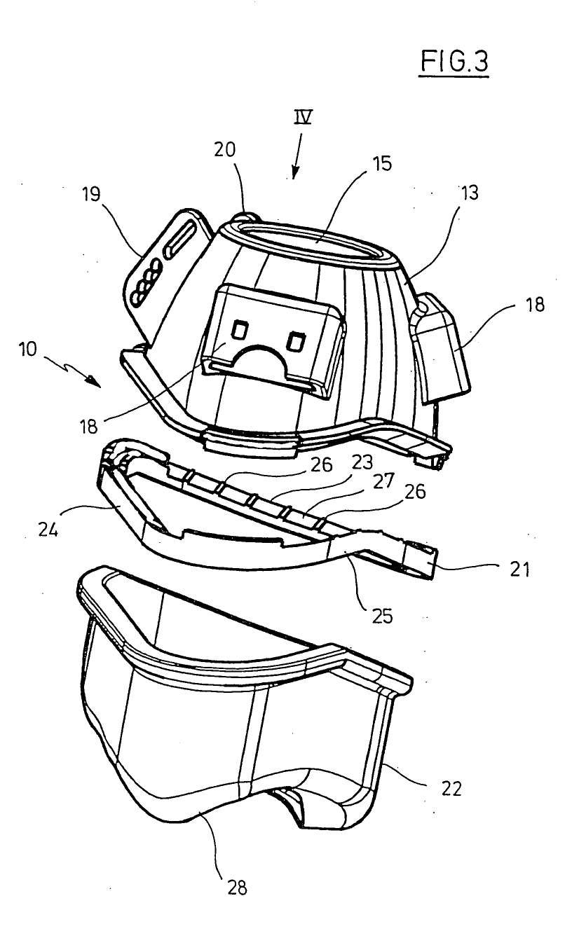

FIG. 3 shows a perspective view of the base 13 of the mask in accordance with FIG. 2 in a rotated position together with a spacing ring 21 and a contour element 22. The spacing ring 21 is shaped to conform to the shape of the edge 17 and thus likewise has an essentially triangular base contour with rounded corner regions. In the region of the border of the spacing ring 21 that faces the base 13 of the mask, the triangular legs 23, 24, 25 of the spacing ring 21 are provided with spacing elements 26, which are formed essentially as webs. The spacing elements 26 extend essentially transversely to the longitudinal direction of the triangular legs 23, 24, 25.

The base 13 of the mask and the spacing ring 21 are typically made of a hard or moderately hard plastic. The contour element is made of a relatively soft plastic, so that it fits comfortably on the patient's face. The flexibility of the contour element 22 is supported especially by sealing lips 28 provided on the contour element 22 in its expanded region that faces away from the base 13 of the mask.

Alternatively to the arrangement of the spacing elements 26 in the area of the spacing ring 21, they can also be formed on the edge 17 of the base 13 of the mask. It is also conceivable to provide both the spacing ring 21 and the base 13 of the mask with spacing elements 26 in their facing expanded regions.

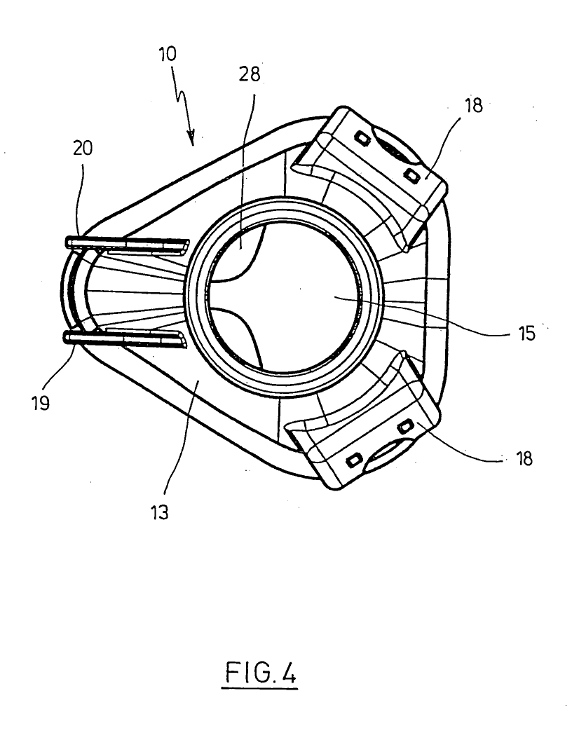

FIG. 4 again illustrates the shape of the base 13 of the mask. In addition, portions of the sealing lips 28 of the contour element 22 are visible through the inlet opening 15.

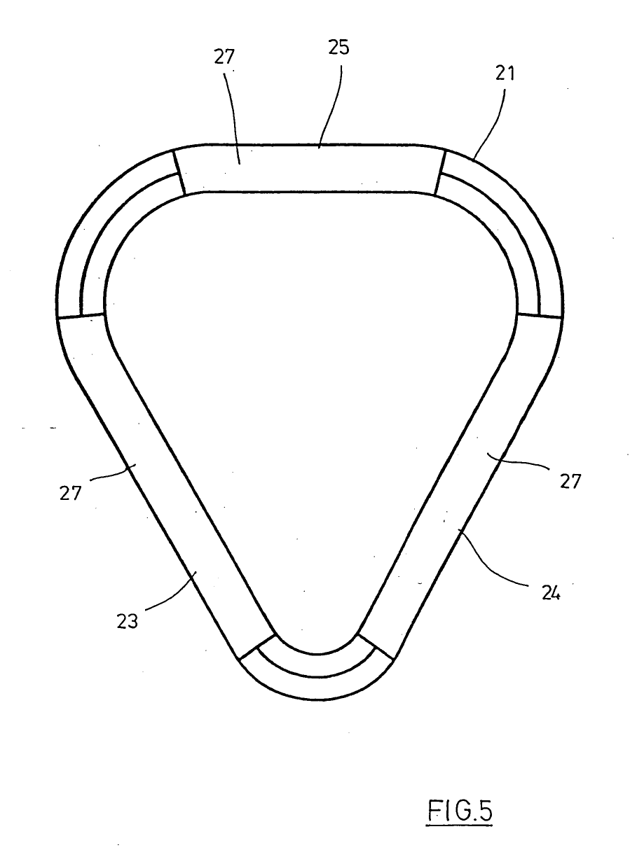

FIG. 5 shows a top view of the spacing ring 21. The drawing shows the surfaces of the triangular legs 23, 24, 25 that bound the outflow channels 27. The spacing elements 26 are not shown in FIG. 5.

The ventilation mask is suitable for carrying out different types of ventilation. For example, CPAP ventilations, APAP ventilations, bilevel ventilations, home ventilation as well as emergency ventilation shall be mentioned. Typically, the ventilation gas is made available from a pressurized gas source and is conducted through a ventilation gas hose to the ventilation mask. For example, the pressurized gas source may be provided with a blower for building up pressure and for conveying the necessary volume flow of ventilation gas.

The outflow channel 27 is made available in the area of the ventilation mask, wherein the outflow channel 27 defines the outflow opening. This provides for a defined leakage of ventilation gas. Ventilation gas and/or gas expired by the patient can continuously flow off through this leakage.

The ventilation mask is constructed as a passive component which is not provided with a valve for actively interrupting or deflecting a gas flow of expired gas. A patient carrying the ventilation mask has to perform only little expiration work or no expiration work at all because the ventilation gas is supplied to the patient with pressure support and the patient therefore does not have to blow the expired air from the mask. However, the expired gas is rinsed out through the expiration gap by the subsequent pressurized fresh ventilation gas and, thus, the expired gas is removed from the area of the ventilation mask. Typically, the used ventilation gas is mixed with fresh ventilation gas in order to accelerate the rinsing process. The fresh incoming ventilation gas which is under excess pressure ensures an effective rinsing of carbon dioxide.

The outflow opening is typically dimensioned in such a way that a pressure range of 0 to 35 mbar is covered by a suitable selection of the length, the width and the height. By optimizing the dimensions, it is possible to use the ventilation mask up to a pressure of 50 mbar. With respect to time, the flow resistance to the ventilation gas is essentially constant. In at least one state of operation, an excess pressure of at least 2 mbar prevails in the interior of the mask, wherein the pressure may increase up to a pressure of 35 mbar.

As illustrated in FIG. 5, the outflow opening is arranged distally relative to the inflow opening and is therefore located at the area of the greater circumference of the mask. As a result of this shape of the ventilation mask, it is possible to achieve a sound level of less than 31 dBa at a distance of one meter from the ventilation mask. This also makes possible a good compliance by the patient.

The flow through the outlet opening typically is 10-30 l/min at a pressure of about 4 hpa. In accordance with a preferred embodiment, the outflow opening extends over more than a third of the circumference of the outer limit of the mask, as illustrated in FIG. 5. The outflow gap typically has a length extension of at least 30 mm. A length extension of at least 40 mm is preferred in order to make available a large outflow area.

The outflow channel has a small width in relation to the length and, consequently, has a narrow shape. A typical width is at most 1.5 mm, preferably at most 1 mm. Particularly preferred is a range of 0.1 and 0.4 mm. The width of the outflow channel is predetermined by the spacer ribs used. The narrow configuration of the outflow channel makes it possible in combination with the large outflow area to provide a diffuse and quiet outflow of the ventilation air.

No further structural elements which could influence the flow are arranged in the outflow channel between the spacing ribs. As illustrated in FIG. 3, the outflow channel has an outflow angle which is directed away from the patient. The outflow angle is formed by the geometry of the transition from the mask body to the spacing element or from the spacing element to the contour element. Moreover, the outflow channel is constructed with a slightly greater length because of the selected outflow angle, so that the sound emission is further reduced.

In order to adapt the ventilation mask to the anatomy of a user, the mask has in the area of its contact surface with the face of the user an essentially triangular basic configuration.

The ventilation mask is composed of only three components. This makes it possible to quickly and easily disassemble the mask for cleaning purposes. Because of the low number of structural components, the manufacturing costs are also low.

The configuration of the ventilation mask of three releasably connected structural components provides the additional advantage that the individual structural components can be easily exchanged. Any structural component which may be defective can be replaced while the other components can be reused.

In accordance with another embodiment, it is also possible to replace the contour element with an alternative transition element, wherein the alternative transition element has a different shape from the originally used contour element. The different shape may refer, for example, to the use of a sealing lip, the material selection or the material hardness.

As a result, an individual adjustment to a face contour of the respective user is possible.

It is also feasible to replace the spacing ring against another differently shaped spacing ring. The differently shaped spacing ring has the purpose of making available different geometries of the outflow channel. Consequently, depending on the therapy pressure required for the respective user, the outflow channels can be adapted to the ventilation gas flow.

Consequently, this provides the advantage for the user that an adjustment of the rinsing of carbon dioxide and the minimization of sound emission can take place which is adapted to the individual requirements of the user in an optimum manner. Such an optimization can be effected by means of providing different heights of the spacer elements which define the outlet channel.

In accordance with another embodiment, it is also possible to further reduce the number of structural components by using the two-component technology. For example, the spacer ring can be adapted with the use of the two-component technology to the contour element and/or the mask body.

While specific embodiments of the invention have been shown and described in detail to illustrate the inventive principles, it will be understood that the invention may be embodied otherwise without departing from such principles.

We claim:

1. A ventilation mask for the ventilation of a patient, the ventilation mask comprising a mask base and a contour element adapted to fit on the patient's face, further comprising at least one outflow channel for respiratory gas, wherein the ventilation mask further comprises a hose connection for coupling a respiratory gas hose which is connected to a pressurized gas source, and wherein the hose connection and the outflow channel are arranged relative to each other such that fresh respiratory gas flowing into the mask flushes out the used ventilation gas from the outflow channel, in a transition zone between the mask base and the contour element.

2. The ventilation mask according to claim 1, wherein at least one of the spacing elements is arranged in an area adjacent to the spacing ring.

3. The ventilation mask according to claim 2, wherein the spacing ring has a contact surface, and wherein the spacing element is arranged in an area of the spacing ring contact surface which faces the mask base.

4. The ventilation mask according to claim 1, wherein the at least one spacing element is arranged in an area adjacent to the mask base.

5. The ventilation mask according to claim 3, wherein the spacing element is arranged in an area of the spacing ring contact surface which faces the contour element.

6. The ventilation mask according to claim 1, wherein the spacing ring bounds an essentially triangular base area with rounded corner regions.

7. The ventilation mask according to claim 6, wherein the spacing ring has triangular legs, and wherein the outflow channel is bounded in an area of at least one of the triangular legs of the spacing ring.

8. The ventilation mask according to claim 7, wherein the outflow channel is bounded in an area of each triangular leg of the spacing ring.

9. The ventilation mask according to claim 1, wherein the spacing ring is of a harder material than the contour element.

10. The ventilation mask according to claim 1, wherein the spacing ring and the contour element are formed as a single piece.

11. The ventilation mask according to claim 10, wherein the spacing ring is injected onto the contour element.

12. The ventilation mask according to claim 10, wherein the spacing ring and the contour element are glued together.

13. The ventilation mask according to claim 10, wherein the spacing ring and the contour element are welded together.

14. The ventilation mask according to claim 1, wherein the spacing ring and the mask base are detachably fastened to one another.

15. The ventilation mask according to claim 14, wherein the spacing ring and the mask base are fastened to one another by a snap connection.

16. The ventilation mask according to claim 14, wherein fastening is effected in transition zones between the triangular legs.
